(19) United States
(12) Patent Application Publication
(10) Pub. No.: US 2026/0366332 A1
(43) Pub. Date: Nov. 19, 2026

(54) DOOR LOCK INDICATOR

(71) Applicant: B/E Aerospace, Inc., Winston-Salem, NC (US)

(72) Inventor: Mark A. Elliott, Winston-Salem, NC (US)

(21) Appl. No.: 19/668,277

(22) Filed: May 5, 2026

Related U.S. Application Data
(60) Provisional application No. 63/805,711, filed on May 14, 2025.

(51) Int. Cl. E05B 41/00; B64C 1/14; B64D 45/00; E05B 65/08

(52) U.S. Cl. CPC E05B 41/00; B64C 1/1438; B64C 1/1461; B64D 45/0005; E05B 65/08

(57) ABSTRACT

A door lock indicator system for confirming a locked condition of a sliding aircraft door. The system includes a first door lock indicator and a second door lock indicator arranged side-by-side on a static structure and independently operable to provide redundant indications of a locked or unlocked condition. A door lock selectively secures the door in a stowed position. A functional interlock associated with the door lock and the indicators permits each indicator to reach a locked-indicating state only when the door is mechanically secured in the stowed position. A blocking mechanism prevents at least one indicator from indicating a locked condition when the door is not properly stowed. The system requires both indicators to confirm a locked condition, thereby providing redundant verification and preventing false locked indications.

### CROSS REFERENCE TO RELATED APPLICATION

This nonprovisional application claims the benefit of priority of U.S. Application No. 63/805,711 filed May 14, 2025, which is hereby incorporated by reference in its entirety.

### TECHNICAL FIELD AND BACKGROUND

The present disclosure relates generally to lock assemblies, and more particularly, to lock indicators for confirming a locked condition of a stowed door, such as a sliding door used in an aircraft cabin environment.

### BACKGROUND

Aircraft passenger cabins may include various doors, partitions, and movable panels, including sliding doors configured to move between a deployed position and a stowed position. During certain phases of flight, including taxi, takeoff, and landing (TTOL), applicable safety requirements and operational procedures may require such doors to be placed in a stowed position and secured to prevent unintended movement.

In order to ensure compliance with these requirements, some aircraft doors are equipped with lock mechanisms configured to retain the door in the stowed position. Additionally, certain aircraft safety guidelines mandate that a visual indicator be provided to confirm whether the door is properly locked when stowed, thereby enabling flight crew or maintenance personnel to quickly verify the locked condition.

Conventional door lock indicators, however, may be susceptible to false-positive indications due to component tolerances, partial engagement of locking features, wear over time, or misalignment between the door and the locking mechanism. In some instances, an indicator may display a locked condition even though the lock is not fully engaged, which may create a safety concern and may fail to satisfy regulatory requirements.

Accordingly, there remains a need for an improved door lock indicator configured to provide a reliable confirmation of a locked condition for a stowed door, particularly in aircraft applications, while preventing false indications of a locked state.

### BRIEF SUMMARY

According to one aspect, a door assembly is disclosed in accordance with one or more illustrative embodiments of the present disclosure. In embodiments, the door assembly includes a static structure, a door slidably coupled to the static structure and movable between a deployed position and a stowed position, a catch coupled to the door, a door lock coupled to the static structure and configured to engage the catch to secure the door in the stowed position, a door lock indicator slidably coupled to the static structure and movable along a vertical direction between a lower locked-indicating position and an upper unlocked-indicating position, the door lock indicator configured to display a first visual indication when the door lock indicator is in the lower locked-indicating position and to display a second visual indication when the door lock indicator is in the upper unlocked-indicating position, and the door lock indicator being biased toward the lower locked-indicating position, and a brace pivotally coupled to the static structure and biased toward a blocking position. The brace, when in the blocking position, is positioned beneath the door lock indicator to physically prevent downward movement of the door lock indicator into the lower locked-indicating position. When the door is in the stowed position, the catch engages the brace to pivot the brace away from the door lock indicator and out of the blocking position such that the door lock indicator is permitted to move downward into the lower locked-indicating position, whereby the door lock indicator is prevented from indicating a locked condition of the door unless the door is in the stowed position.

In some embodiments, the door lock indicator is biased toward the lower locked-indicating position by gravity or by a spring.

In some embodiments, the first visual indication includes a first color coding and the second visual indication includes a second color coding different from the first color coding.

In some embodiments, the brace is spring-loaded such that the brace automatically pivots into the blocking position when the catch disengages from the brace.

In some embodiments, the door lock indicator is configured such that upward movement of the door lock indicator from the lower locked-indicating position causes disengagement of the door lock from the catch.

In some embodiments, the door lock includes a pivoting lock configured to pivot between an engaged position engaging the catch and a disengaged position spaced from the catch.

In some embodiments, the pivoting lock defines a slot, and wherein the door lock indicator includes a roller received within the slot such that movement of the door lock indicator causes pivoting movement of the pivoting lock.

In some embodiments, the assembly further includes a second door lock configured to engage the catch, and a second door lock indicator slidably coupled to the static structure and operatively coupled to the second door lock, the second door lock indicator independently movable between a second lower locked-indicating position and a second upper unlocked-indicating position.

In some embodiments, the assembly further includes an arm pivotally coupled to the static structure and biased toward the door lock indicator, wherein the arm includes a detent configured to engage a bearing of the door lock indicator to resist sliding movement of the door lock indicator.

In some embodiments, the door assembly is installed in an aircraft cabin such that the door lock indicator is positioned on an end wall of the static structure and is visible to flight crew.

According to another aspect, a door lock indicator assembly for a door movable relative to a static structure is disclosed in accordance with one or more illustrative embodiments of the present disclosure. In embodiments, the door lock indicator assembly includes a door lock indicator configured to be slidably coupled to the static structure and movable along a vertical direction between a lower locked-indicating position and an upper unlocked-indicating position, the door lock indicator configured to display a first visual indication when the door lock indicator is in the lower locked-indicating position and to display a second visual indication when the door lock indicator is in the upper unlocked-indicating position, and the door lock indicator being biased toward the lower locked-indicating position, a brace configured to be pivotally coupled to the static structure and biased toward a blocking position, and a catch configured to be coupled to the door, wherein the brace, when in the blocking position, is positioned beneath the door lock indicator to physically prevent downward movement of the door lock indicator into the lower locked-indicating position, and wherein the catch is configured to engage the brace when the door is in a stowed position to pivot the brace away from the door lock indicator and out of the blocking position such that the door lock indicator is permitted to move into the lower locked-indicating position, whereby the door lock indicator is prevented from indicating a locked condition unless the door is in the stowed position.

According to a further aspect, a door lock indicator system for a sliding door movable relative to a static structure is disclosed in accordance with one or more illustrative embodiments of the present disclosure. In embodiments, the door lock indicator system includes a first door lock indicator configured to be movably coupled to the static structure to provide a first indication of whether the door is in a locked condition, a second door lock indicator configured to be movably coupled to the static structure to provide a second indication of whether the door is in the locked condition, wherein the first door lock indicator and the second door lock indicator are configured to be arranged side-by-side on the static structure and are independently movable, a door lock configured to selectively secure the door in a stowed position, a functional interlock operatively associated with the door lock, the first door lock indicator, and the second door lock indicator, wherein the functional interlock is configured such that each of the first door lock indicator and the second door lock indicator is permitted to indicate the locked condition only when the door is mechanically secured in the stowed position, and a blocking mechanism operatively associated with the first door lock indicator and the second door lock indicator, the blocking mechanism configured to prevent at least one of the first door lock indicator or the second door lock indicator from indicating the locked condition when the door is not in the stowed position.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are exemplary and explanatory only and are not necessarily restrictive of the subject matter claimed.

### BRIEF DESCRIPTION OF THE DRAWINGS

Implementations of the inventive concepts disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 illustrates a door assembly, in accordance with example embodiments of this disclosure;

FIG. 2 illustrates a redundant door lock indicator shown in a disposition indicating a stowed and locked condition of a door, in accordance with example embodiments of this disclosure;

FIG. 3 illustrates the redundant door lock indicator shown in a disposition indicating an unlocked condition of a door, in accordance with example embodiments of this disclosure;

FIG. 4 illustrates the redundant door lock indicator shown in a disposition indicating a stowed and locked condition of a door, in accordance with example embodiments of this disclosure;

FIG. 5 illustrates the redundant door lock indicator shown in a disposition indicating an unlocked condition of a door, in accordance with example embodiments of this disclosure;

FIG. 6 illustrates a stowed and locked door and the disposition of the door lock indicator confirming the stowed and locked condition of the door, in accordance with example embodiments of this disclosure;

FIG. 7 illustrates the door in the state of being unlocked and the corresponding disposition of the door lock indicator, in accordance with example embodiments of this disclosure;

FIG. 8 illustrates the door unlocked and the corresponding disposition of the door lock indicator, in accordance with example embodiments of this disclosure; and

FIG. 9 illustrates the door moved to a deployed condition and the corresponding disposition of the door lock indicator, in accordance with example embodiments of this disclosure.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, in an aircraft cabin interior application, the disclosed door lock indicator system provides a functional, safety-focused mechanism for confirming whether a movable cabin door is properly secured in a stowed condition. The system is particularly suited for use with sliding doors or partitions that must be restrained during taxi, takeoff, and landing (TTOL), where inadvertent movement or improper locking could present operational or safety concerns.

Functionally, the system provides redundant, side-by-side visual confirmation of door status through first and second independently operable door lock indicators. Each indicator is configured to present a locked indication only when the door is mechanically secured in the correct stowed position. Rather than relying solely on electronic sensing or a single mechanical signal path, the system uses a physical interlock relationship between the door, a lock mechanism, and a blocking feature to ensure that a locked indication cannot be achieved unless the door is properly secured.

In use, the indicators are enabled to reach a locked-indicating state only when the door is fully stowed and the associated lock mechanism is properly engaged. If the door is not fully stowed or if the locking condition is not satisfied, a blocking mechanism physically prevents one or both indicators from moving into the locked-indicating position, thereby inhibiting any false indication of a secure state. This arrangement enhances operational safety in the aircraft cabin by ensuring that flight crew can rely on clear, redundant, and mechanically enforced visual confirmation of door status. Although adaptable to other environments, the system is particularly advantageous in aircraft environments where reliability, fail-safe behavior, and resistance to misleading indications are critical to compliance with safety procedures during flight operations.

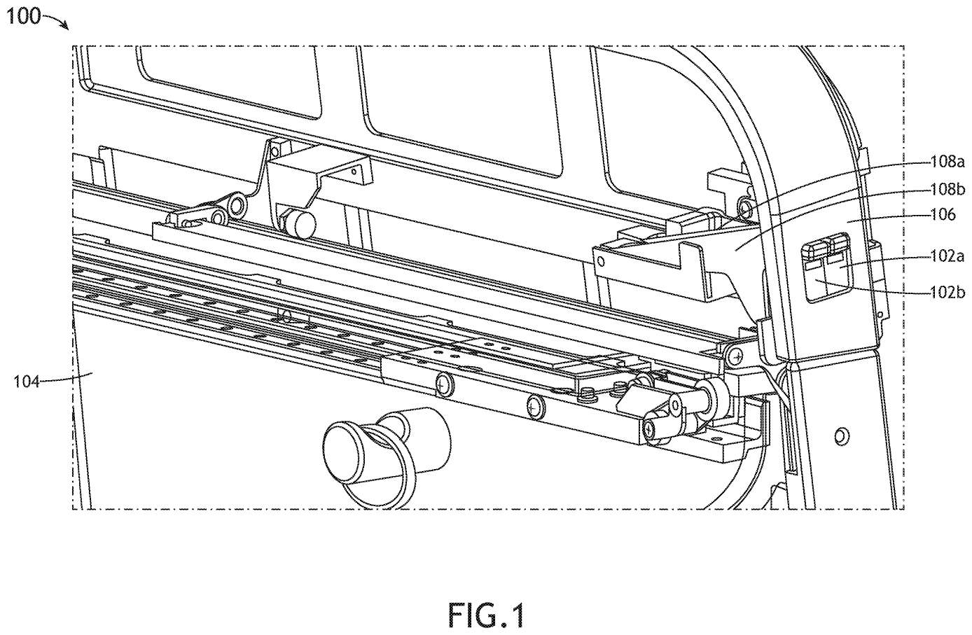

FIGS. 1-9 illustrates a door assembly 100 configured for use with redundant door lock indicators 102a, 102b according to the present disclosure. In embodiments, the door assembly 100 is implemented in an aircraft cabin interior environment and is particularly suited for selectively securable cabin doors or partitions that must be stowed during taxi, takeoff, and landing (TTOL). The door assembly 100 includes a door 104 slidably mounted relative to a static structure 106 such that the door 104 is movable between a deployed position and a stowed position. In embodiments, the static structure 106 forms part of an aircraft cabin wall or monument structure, and the door 104 is guided along a defined translation path to selectively open or close a compartment or passageway within the cabin.

In embodiments, the door assembly 100 further includes an Emergency Passage Function (EPF) implemented as a redundant rail assembly that permits controlled movement of the door 104 while maintaining safety-critical guidance and retention characteristics. In a non-limiting example, a rail assembly guides the sliding movement of the door and is configured to operate in both a functioning door condition and a malfunction condition. In the malfunction condition, a first portion of the rail assembly inhibits translation of a carriage, while a second portion of the rail assembly permits movement of the door relative to the carriage to allow the door to be moved out of the way (e.g., stowed). In such a malfunction condition, a second portion of the rail assembly is configured to permit movement of the door 104 relative to the carriage so that the door 104 can still be moved to a stowed position. In this manner, the rail assembly provides a redundant movement capability if a component of the rail assembly malfunctions or becomes inoperable.

The door assembly 100 includes redundant pivoting door locks 108a, 108b corresponding to the door lock indicators 102a, 102b and configured to mechanically interface with corresponding features of the door 104, such as catches 114, to secure the door 104 in a fully stowed condition. The pivoting door locks 108a, 108b are configured to prevent translational movement of the door 104 when engaged, thereby ensuring that the door 104 remains fixed during aircraft operation.

The door lock indicators 102a, 102b are slidably mounted to the static structure 106, for example on an end wall or other surface visible to flight crew or cabin personnel. In embodiments, the door lock indicators 102a, 102b are positioned in a side-by-side arrangement such that both indicators may be simultaneously observed, thereby providing redundant visual confirmation of the locking state of the door 104. Each of the door lock indicators 102a, 102b is independently movable relative to the static structure 106 and is functionally coupled to a corresponding locking mechanism such that indicator position reflects the mechanical state of the door assembly 100.

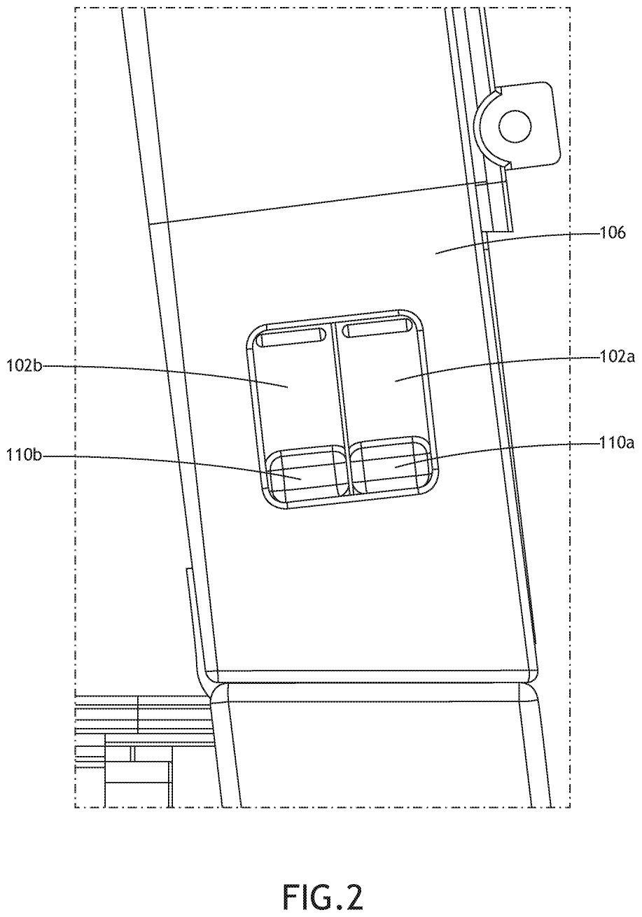

FIG. 2 illustrates the redundant door lock indicators 102a, 102b in a disposition corresponding to a confirmed stowed and locked condition of the door 104. In this condition, both of the door lock indicators 102a, 102b are positioned in a lower locked-indicating position providing affirmative visual indication of a secure state. In embodiments, each of the door lock indicators 102a, 102b is configured to move along a generally vertical path between a lower locked-indicating position and an upper unlocked-indicating position. Each of the door lock indicators 102a, 102b may include a handle 110a, 110b or other feature configured to allow a user to manually engage and move the respective indicator to initiate a release sequence for the door 104. In particular, upward movement of each door lock indicator 102a, 102b is functionally linked to disengagement of the associated pivoting door lock 108a, 108b, thereby initiating unlocking of the door 104.

In the illustrated locked condition, both door lock indicators 102a, 102b are positioned at their lowest vertical positions, which are enabled only when the door 104 is fully stowed and mechanically secured. In embodiments, each door lock indicator 102a, 102b may be biased toward this lower position such that, when permitted by the mechanical interlock system, the indicators naturally settle into the locked-indicating state. As such, the door lock indicators 102a, 102b function not only as visual status devices but also as functional control inputs for initiating door release, thereby integrating indication and actuation into a unified safety interface. In embodiments, the redundant nature of the door lock indicators 102a, 102b ensures that each indicator operates independently such that a fault in one indicator does not affect the ability of the other indicator to provide a valid condition signal.

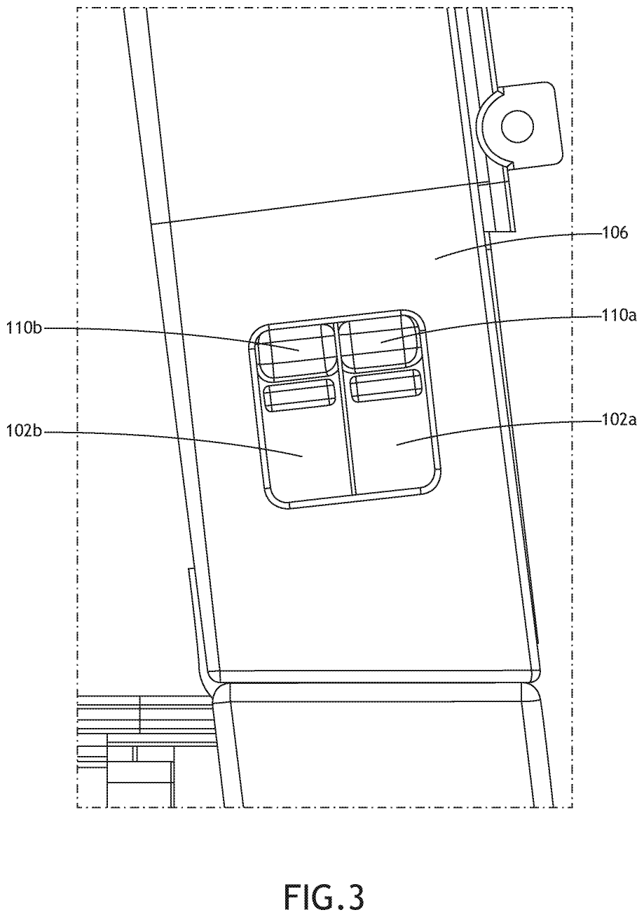

FIG. 3 illustrates the redundant door lock indicators 102a, 102b in an unlocked condition corresponding to a non-stowed or partially stowed state of the door 104. In this condition, both door lock indicators 102a, 102b are positioned in an upper disposition corresponding to an “unlocked” visual indication. The raised position reflects that the door 104 is not fully secured in the stowed position and that the associated pivoting door locks 108a, 108b are not engaged with the catches 114. In embodiments, movement of the door lock indicators 102a, 102b to this upper position is associated with or results from manual actuation of the handles 110a, 110b, which in turn drives disengagement of the locking mechanisms. This arrangement ensures that the door lock indicators 102a, 102b provide direct and intuitive feedback regarding the mechanical state of the door 104.

In embodiments, the door lock indicators 102a, 102b may be color coded or otherwise visually marked to help indicate their current disposition. For example, the door lock indicators 102a, 102b may display a first color coding (e.g., green) when in the lower locked-indicating position, and a second color coding (e.g., red) when in the upper unlocked-indicating position to present a visual indication to the cabin crew. In use, when the door lock indicators 102a, 102b are positioned in their lower locked-indicating position, the first color coding is revealed and the second color coding in concealed, and vice versa when the indicators are positioned in their upper unlocked-indicating position.

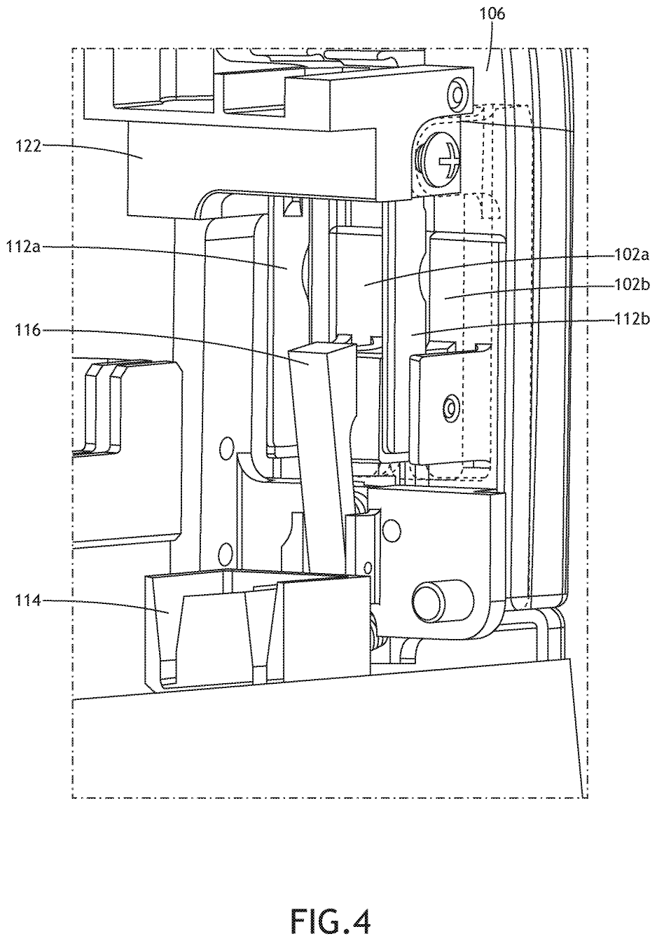

FIG. 4 illustrates the door lock indicators 102a, 102b in a confirmed locked state with additional emphasis on mechanical stabilization and controlled motion. In embodiments, corresponding arms 112a, 112b are pivotally mounted to the static structure 106, for instance via a mounting block 122, and are biased toward engagement with the respective door lock indicators 102a, 102b. The arms 112a, 112b are configured to provide controlled interaction with the respective door lock indicators 102a, 102b via detent features that engage rollers or bearings associated with each indicator. This interaction functions to dampen movement of the indicators 102a, 102b, reduce vibration-induced displacement, and prevent unintended lowering or falling of the indicators under gravity or operational vibration. Thus, the arms 112a, 112b provide a stabilizing force that maintains indicator position unless positively driven by the mechanical state of the door assembly 100.

In embodiments, the door assembly 100 includes a catch 114 mounted to the door 104 and configured to engage a pivoting, spring-loaded brace 116 when the door 104 is in a fully stowed position. When the door 104 reaches the fully stowed position, the catch 114 displaces the pivoting brace 116 away from the door lock indicators 102a, 102b, thereby removing a physical obstruction that would otherwise prevent the indicators from reaching the lower locked-indicating position. This displacement enables the door lock indicators 102a, 102b to descend into their locked-indicating positions only when the door 104 is properly stowed and the locking condition is satisfied.

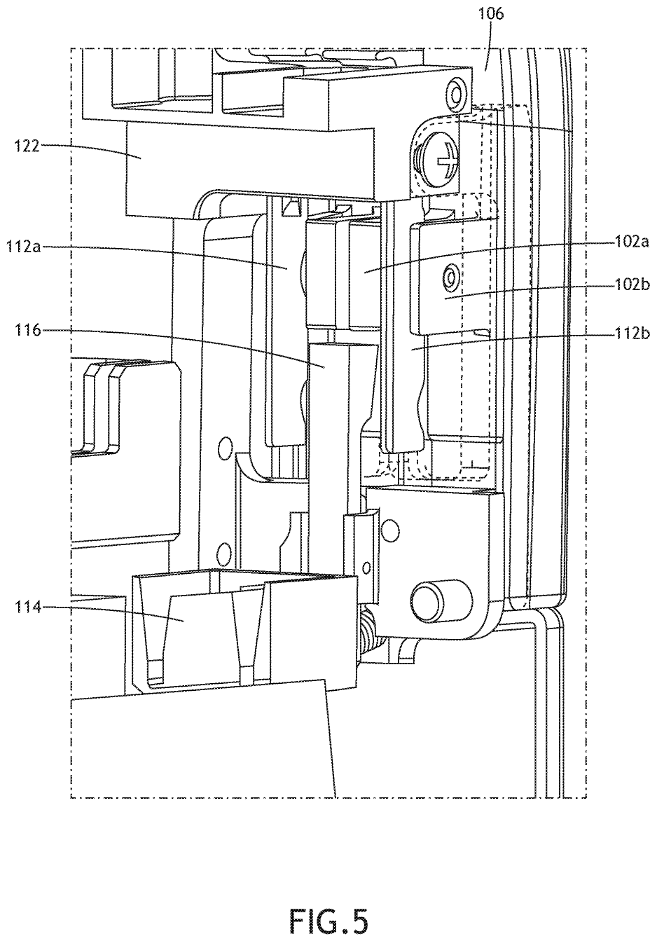

Conversely, as shown in FIG. 5, when the door 104 begins to deploy or is not fully stowed, the catch 114 disengages from the pivoting brace 116. In response, the spring-loaded bias of the brace 116 causes the brace 116 to pivot toward the door lock indicators 102a, 102b. In this blocking disposition, the brace 116 is positioned to physically interfere with downward movement of the indicators 102a, 102b, thereby preventing the indicators from falsely indicating a locked condition when the door 104 is not properly secured. This functional interlock ensures that indicator position is strictly dependent on the true mechanical state of the door assembly 100.

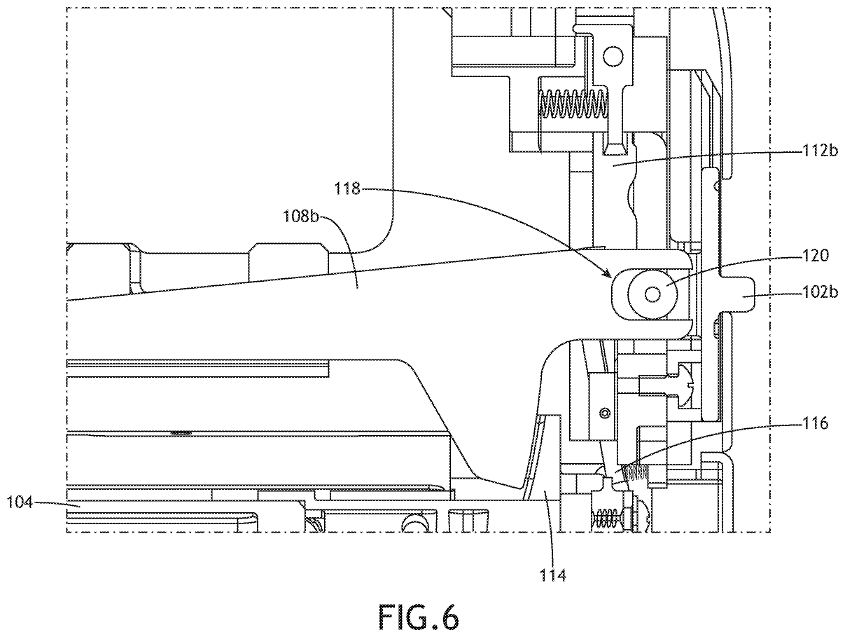

FIG. 6-9 further illustrate, viewed from one side of the door assembly for clarity, coordinated interaction between the pivoting door lock 108b, the catch 114, the respective door lock indicator 102b, and the pivoting brace 116 across different operational states of the door 104. While one pivoting door lock and door lock indicator is shown, it is understood that the other door lock and respective indicator function in the same manner, for instance simultaneously.

As shown in FIG. 6, when the door 104 is fully stowed and locked, the pivoting door lock 108b is engaged with the catch 114 to prevent translational movement of the door 104. In embodiments, the door lock 108b includes slot features 118 that receive rollers or bearings 120 associated with the respective door lock indicators 102b, thereby mechanically coupling indicator movement to lock engagement. In this state, the catch 114 simultaneously engages and displaces the pivoting brace 116 away from the indicator 102b, enabling the indicator to assume its lower locked-indicating position.

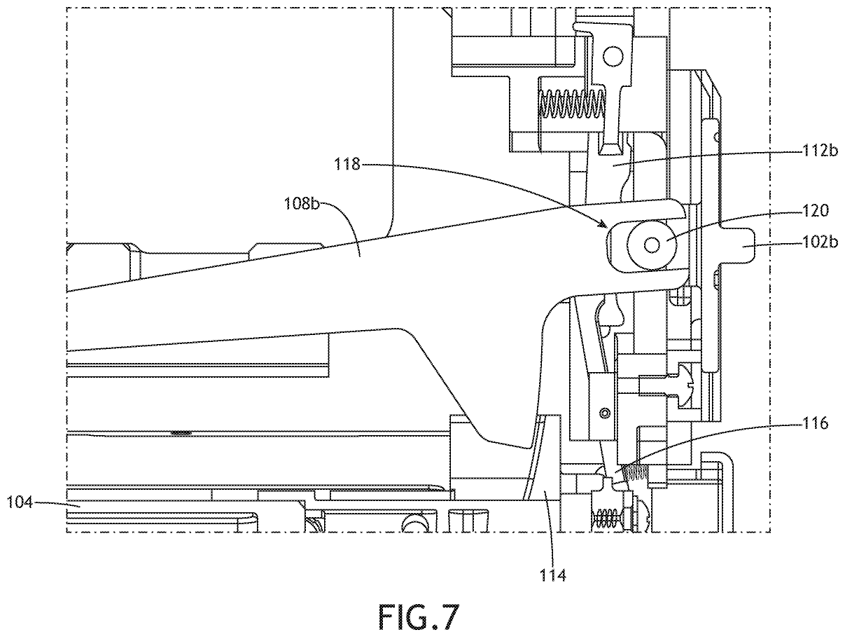

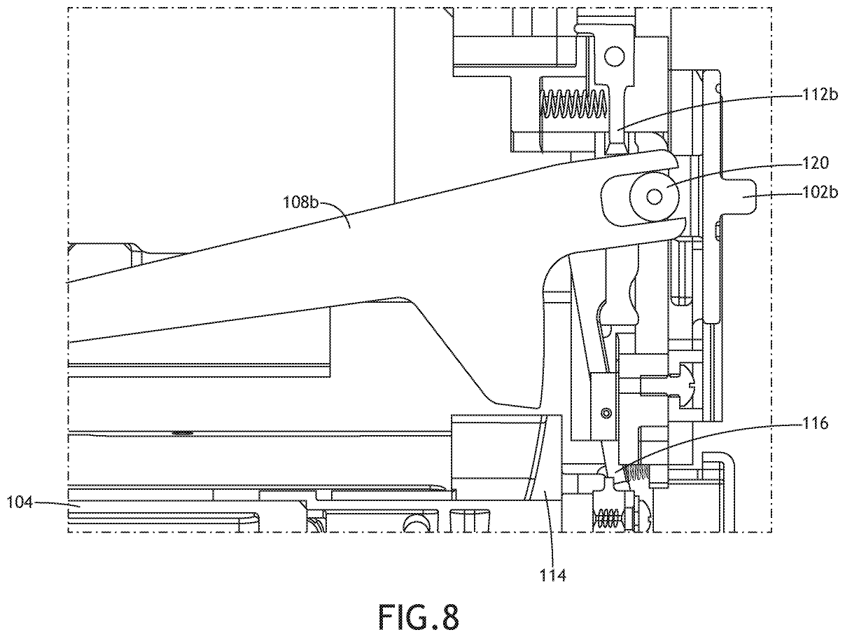

FIG. 7 illustrates a transitional state in which upward movement of the door lock indicator 102b initiates lifting of the pivoting door lock 108b out of engagement with the catch 114. This coordinated motion demonstrates the functional coupling between indicator actuation and lock release, whereby the indicators serve both as status displays and as control interfaces for unlocking the door 104. FIG. 8 illustrates a fully unlocked condition in which the door lock indicator 102b is in its upper position and the pivoting door lock 108b is fully disengaged from the catch 114, permitting movement of the door 104 away from the stowed position.

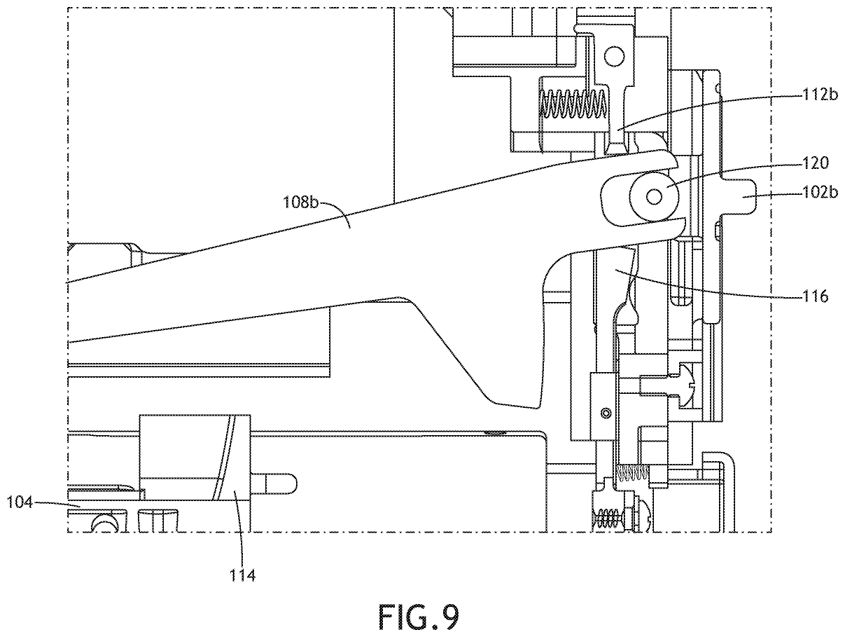

FIG. 9 illustrates a deployment phase in which the door 104 is moving away from the stowed position. In this condition, the catch 114 is disengaged from the pivoting brace 116, allowing the spring bias of the brace 116 to pivot the brace 116 into its blocking position. In this configuration, the brace 116 is positioned beneath or adjacent to the door lock indicator 102b such that it prevents the indicator from descending into a position that would falsely suggest that the door 104 is stowed and locked. This ensures that at no time during partial engagement, misalignment, or unintended movement of the door 104 can the system present an incorrect locked indication.

As described herein, the door assembly 100 provides a functionally interlocked, redundant, and mechanically enforced indication system in which the state of the door lock indicators 102a, 102b is directly governed by the actual mechanical condition of the door 104 and its locking elements. The system thereby enhances operational safety in aircraft cabin environments by ensuring that locked indications are only presented when the door is truly stowed and mechanically secured, while preventing any false indication of a locked condition under all non-conforming states.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A door assembly, comprising:
a static structure;
a door slidably coupled to the static structure, the door movable between a deployed position and a stowed position;
a catch coupled to the door;
a door lock coupled to the static structure and configured to engage the catch to secure the door in the stowed position; and
a door lock indicator slidably coupled to the static structure and movable along a vertical direction between a lower locked-indicating position and an upper unlocked-indicating position, the door lock indicator configured to display a first visual indication when the door lock indicator is in the lower locked-indicating position and to display a second visual indication when the door lock indicator is in the upper unlocked-indicating position, and the door lock indicator being biased toward the lower locked-indicating position; and
a brace pivotally coupled to the static structure and biased toward a blocking position;
wherein the brace, when in the blocking position, is positioned beneath the door lock indicator to physically prevent downward movement of the door lock indicator into the lower locked-indicating position; and
wherein, when the door is in the stowed position, the catch engages the brace to pivot the brace away from the door lock indicator and out of the blocking position such that the door lock indicator is permitted to move downward into the lower locked-indicating position, whereby the door lock indicator is prevented from indicating a locked condition of the door unless the door is in the stowed position.

2. The door assembly of claim 1, wherein the door lock indicator is biased toward the lower locked-indicating position by gravity or by a spring.

3. The door assembly of claim 1, wherein the first visual indication comprises a first color coding and the second visual indication comprises a second color coding different from the first color coding.

4. The door assembly of claim 1, wherein the brace is spring-loaded such that the brace automatically pivots into the blocking position when the catch disengages from the brace.

5. The door assembly of claim 1, wherein the door lock indicator is configured such that upward movement of the door lock indicator from the lower locked-indicating position causes disengagement of the door lock from the catch.

6. The door assembly of claim 1, wherein the door lock comprises a pivoting lock configured to pivot between an engaged position engaging the catch and a disengaged position spaced from the catch.

7. The door assembly of claim 6, wherein the pivoting lock defines a slot, and wherein the door lock indicator includes a roller received within the slot such that movement of the door lock indicator causes pivoting movement of the pivoting lock.

8. The door assembly of claim 1, further comprising:
a second door lock configured to engage the catch; and
a second door lock indicator slidably coupled to the static structure and operatively coupled to the second door lock, the second door lock indicator independently movable between a second lower locked-indicating position and a second upper unlocked-indicating position.

9. The door assembly of claim 1, further comprising an arm pivotally coupled to the static structure and biased toward the door lock indicator, wherein the arm includes a detent configured to engage a bearing of the door lock indicator to resist sliding movement of the door lock indicator.

10. The door assembly of claim 1, wherein the door assembly is installed in an aircraft cabin such that the door lock indicator is positioned on an end wall of the static structure and is visible to flight crew.

11. A door lock indicator assembly for a door movable relative to a static structure, the door lock indicator assembly comprising:
a door lock indicator configured to be slidably coupled to the static structure and movable along a vertical direction between a lower locked-indicating position and an upper unlocked-indicating position, the door lock indicator configured to display a first visual indication when the door lock indicator is in the lower locked-indicating position and to display a second visual indication when the door lock indicator is in the upper unlocked-indicating position, and the door lock indicator being biased toward the lower locked-indicating position;
a brace configured to be pivotally coupled to the static structure and biased toward a blocking position; and
a catch configured to be coupled to the door;
wherein the brace, when in the blocking position, is positioned beneath the door lock indicator to physically prevent downward movement of the door lock indicator into the lower locked-indicating position; and
wherein the catch is configured to engage the brace when the door is in a stowed position to pivot the brace away from the door lock indicator and out of the blocking position such that the door lock indicator is permitted to move into the lower locked-indicating position, whereby the door lock indicator is prevented from indicating a locked condition unless the door is in the stowed position.

12. The door lock indicator assembly of claim 11, wherein the door lock indicator is biased toward the lower locked-indicating position by gravity or by a spring.

13. The door lock indicator assembly of claim 11, further comprising a pivoting lock configured to engage the catch to secure the door in the stowed position, wherein the pivoting lock defines a slot, and wherein the door lock indicator includes a roller received within the slot such that movement of the door lock indicator causes pivoting movement of the pivoting lock.

14. The door lock indicator assembly of claim 11, further comprising a second door lock indicator slidably configured to be slidably coupled to the static structure and movable along the vertical direction between a second lower locked-indicating position and a second upper unlocked-indicating position, wherein the door lock indicator and the second door lock indicator are mechanically independent such that movement of one of the door lock indicator and the second door lock indicator does not mechanically force movement of the other.

15. The door lock indicator assembly of claim 14, wherein the door lock indicator and the second door lock indicator are independently coupled to separate respective door locks.

16. The door lock indicator assembly of claim 14, wherein the door lock indicator and the second door lock indicator are each configured such that each of the door lock indicator and the second door lock indicator is independently prevented from reaching the respective lower locked-indicating position unless the door is in the stowed position.

17. The door lock indicator assembly of claim 14, wherein the brace is configured to block movement of both the door lock indicator and the second door lock indicator into their respective lower locked-indicating positions when the door is not in the stowed position.

18. The door lock indicator assembly of claim 14, wherein the door lock indicator and the second door lock indicator are arranged side-by-side and provide redundant visual confirmation such that both the door lock indicator and the second door lock indicator must be in their respective lower locked-indicating positions to indicate a confirmed locked condition.

19. A door lock indicator system for a sliding door movable relative to a static structure, the door lock indicator system comprising:
a first door lock indicator configured to be movably coupled to the static structure to provide a first indication of whether the door is in a locked condition;
a second door lock indicator configured to be movably coupled to the static structure to provide a second indication of whether the door is in the locked condition, wherein the first door lock indicator and the second door lock indicator are configured to be arranged side-by-side on the static structure and are independently movable;
a door lock configured to selectively secure the door in a stowed position;
a functional interlock operatively associated with the door lock, the first door lock indicator, and the second door lock indicator, wherein the functional interlock is configured such that each of the first door lock indicator and the second door lock indicator is permitted to indicate the locked condition only when the door is mechanically secured in the stowed position; and
a blocking mechanism operatively associated with the first door lock indicator and the second door lock indicator, the blocking mechanism configured to prevent at least one of the first door lock indicator or the second door lock indicator from indicating the locked condition when the door is not in the stowed position.

20. The door lock indicator system of claim 19, wherein the door lock indicator system is configured such that a valid locked condition is indicated only when both the first door lock indicator and the second door lock indicator independently indicate the locked condition, and wherein the door lock indicator system is further configured such that a false locked indication is prevented when the door is not secured in the stowed position.
